(19) United States
(12) Patent Application Publication
(10) Pub. No.: US 2024/0251294 A1
(43) Pub. Date: Jul. 25, 2024

(54) CONTROL SYSTEM, CONTROL METHOD, CONTROLLER, AND PROGRAM

(71) Applicant: NIPPON TELEGRAPH AND TELEPHONE CORPORATION, Tokyo (JP)

(72) Inventors: Yuki SAKAUE, Musashino-shi, Tokyo (JP); Katsuya MINAMI, Musashino-shi, Tokyo (JP); Tatsuya FUKUI, Musashino-shi, Tokyo (JP); Ryohei TSUGAMI, Musashino-shi, Tokyo (JP)

(73) Assignee: NIPPON TELEGRAPH AND TELEPHONE CORPORATION, Tokyo (JP)

(21) Appl. No.: 18/564,404

(22) PCT Filed: Jun. 18, 2021
(86) PCT No.: PCT/JP2021/023197

§ 371 Date: Nov. 27, 2023

(51) Int. Cl. H04W 28/14

(52) U.S. Cl. CPC H04W 28/14

(57) ABSTRACT

An object of the present disclosure is to enable band allocation on a traffic flow basis even in a real wireless network in which a terminal repeats connection/disconnection in association with movement of a person or the like.

The present disclosure relates to a control system for controlling traffic in a wireless network. The control system includes a controller that performs transmission control on a terminal and an access point. Before the access point establishes a connection with the terminal, the controller establishes a connection with the terminal using a connection sequence according to a protocol available in the wireless network, and acquires, from the terminal, information about a node number and a flow-based buffer of the terminal. After the access point establishes a connection with the terminal, the controller performs transmission control for each traffic flow accumulated in the flow-based buffer of the terminal using the acquired information about the node number and the flow-based buffer of the terminal.

### TECHNICAL FIELD

The present disclosure relates to a control system, a control method, a controller, and a program for allocating a communication band in an access network.

### BACKGROUND ART

In recent years, studies have been underway to accommodate a plurality of services and applications with various network requirements in the same network infrastructure. To this end, the qualities requested by services or applications accommodated in the same network must be guaranteed in End-to-End sections such as a “terminal to terminal section” or a “terminal to application server section.”

The End-to-End sections of the network can be divided into wireless and wired sections. Among them, in the wireless section, there is a priority control function called IEEE 802.11 Enhanced Distributed Channel Access (EDCA) as an existing technology (NPL 1 and 2).

EDCA is controlled on a terminal (destination) basis, and it is difficult to control on a traffic flow basis such as to enable quality control on a service and application basis. Therefore, technologies have been proposed to realize quality control on a service and application basis (see, for example, NPL 3).

### CITATION LIST

### Non Patent Literature

[NPL 1] IEEE 802.11e-2005—IEEE Standard for Information technology—Local and metropolitan area networks—Specific requirements—Part 11: Wireless LAN Medium Access Control (MAC) and Physical Layer (PHY) Specifications—Amendment 8: Medium Access Control (MAC) Quality of Service Enhancements
[NPL 2] IEEE 802.11e-QOS Enhanced Wireless LAN Standard” Journal of the Institute of Image Information and Television Engineers Vol. 57, No. 11
[NPL 3] Yuki Sakaue, Kazuki Aiura, Tatsuya Fukui, and others: “Proposal of quality control technology by centralized control independent of wireless network,” Institute of Electronics, Information and Communication Engineers General Conference Mar. 9, 2021, B-6-5

### SUMMARY OF INVENTION

### Technical Problem

In NPL 3, it is necessary to record terminals and access points connected in advance in a database unit, but in an actual terminal in a wireless network, since connection/disconnection is repeated in accordance with movement of a person, it is difficult to record all terminals and access points in advance in a controller.

An object of the present disclosure is to enable band allocation on a traffic flow basis even in a real wireless network in which a terminal repeats connection/disconnection in association with movement of a person or the like.

### Solution to Problem

A control system according to the present disclosure is a control system for controlling traffic in a wireless network, the control system including:
a terminal and an access point which mutually transmit packets over the wireless network; and
a controller which performs transmission control on the terminal and the access point, in which:
the terminal holds in advance information about a node number and a flow-based buffer of its own device;
before the access point establishes a connection with the terminal, the controller establishes a connection with the terminal using a connection sequence according to a protocol available in the wireless network, and
acquires, from the terminal, the information about the node number and the flow-based buffer of the terminal through the wireless network; and
after the access point establishes a connection with the terminal, the controller performs transmission control for each traffic flow accumulated in the flow-based buffer of the terminal using the information about the node number and the flow-based buffer of the terminal acquired through the wireless network.

A control method according to the present disclosure is a control method for controlling traffic in a wireless network,
the control method being transmission control performed by a controller on a terminal and an access point which mutually transmit packets over the wireless network, the control method including:
before the access point establishes a connection with the terminal,
by the controller,
establishing a connection with the terminal using a connection sequence according to a protocol available in the wireless network, and
acquiring, from the terminal, the information about the node number and the flow-based buffer of its own device held in advance by the terminal through the wireless network; and after the access point establishes a connection with the terminal,
by the controller, performing transmission control for each traffic flow accumulated in the flow-based buffer of the terminal using the information about the node number and the flow-based buffer of the terminal acquired through the wireless network.

A controller according to the present disclosure is a controller for controlling traffic in a wireless network, the controller being a device that performs transmission control on a terminal and an access point which mutually transmit packets over the wireless network, in which:
before the access point establishes a connection with the terminal,
the controller establishes a connection with the terminal using a connection sequence according to a protocol available in the wireless network, and
acquires, from the terminal, the information about the node number and the flow-based buffer of its own device held in advance by the terminal through the wireless network; and after the access point establishes a connection with the terminal,
the controller performs transmission control for each traffic flow accumulated in the flow-based buffer of the terminal using the information about the node number and the flow-based buffer of the terminal acquired through the wireless network.

A program according to the present disclosure is a program for causing a computer to realize functional units provided in the device according to the present disclosure, and is a program for causing a computer to execute steps of the method executed by the device according to the present disclosure.

### Advantageous Effects of Invention

According to the present disclosure, it is possible to allocate a band on a traffic flow basis even in a real wireless network in which a terminal repeats connection/disconnection in association with movement of a person or the like.

### BRIEF DESCRIPTION OF DRAWINGS

FIG. 1 illustrates an example of a system configuration of the present disclosure.

FIG. 2 illustrates a configuration example of an access point.

FIG. 3 is a diagram illustrating a database provided in the access point.

FIG. 4 illustrates a configuration example of a controller.

FIG. 5 is a diagram illustrating a database provided in the controller.

FIG. 6 illustrates a configuration example of a terminal.

FIG. 7 is a diagram illustrating a database provided in the terminal.

FIG. 8 illustrates a flowchart of a terminal making a new connection.

FIG. 9 illustrates a flowchart of the terminal making a new connection.

FIG. 10 is a diagram illustrating the operation of the system of the present disclosure in a flowchart.

FIG. 11 is a sequence diagram of a control system of the present disclosure.

FIG. 12 is a sequence diagram in a conventional communication system with no controller.

### DESCRIPTION OF EMBODIMENTS

Embodiments of the present disclosure will be described hereinafter in detail with reference to the drawings. It is to be understood that the present disclosure is not limited to the embodiments described below. The embodiments are merely exemplary and the present disclosure can be implemented in various modified and improved modes based on knowledge of those skilled in the art. Constituent elements with the same reference signs in the present specification and in the drawings represent the same constituent elements.

### First Embodiment

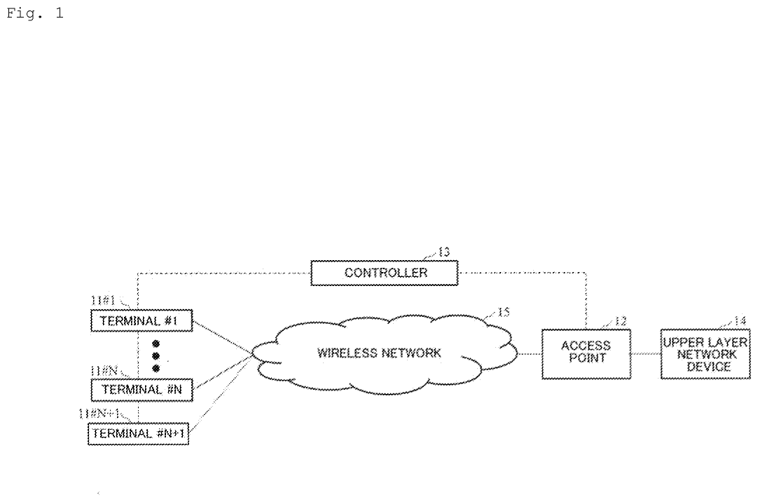

FIG. 1 illustrates an example of a system configuration of the present disclosure. In the communication network of the present disclosure, each terminal 11 is connected to an access point 12 through a wireless network 15. A control system of the present disclosure includes a controller 13 that controls the communication network. The controller 13 is connected to the access point 12 through a dedicated control network. The controller 13 is connected to each terminal 11 using a connection sequence according to a protocol available in the wireless network 15.

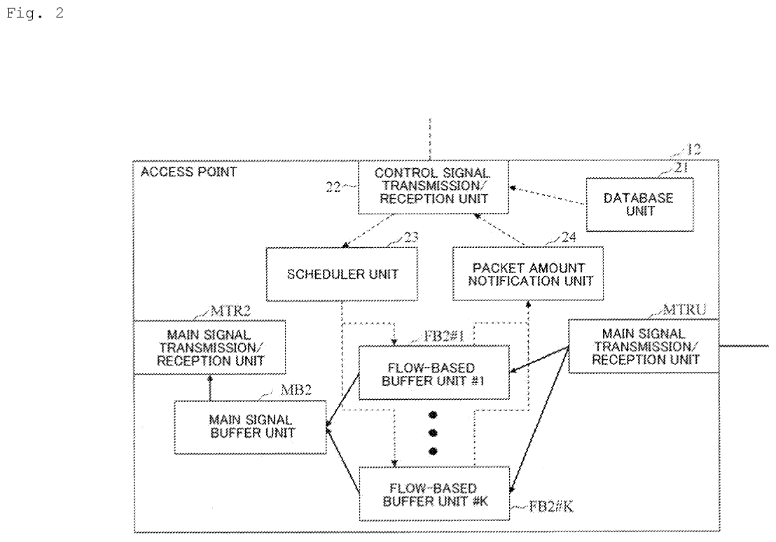

FIG. 2 illustrates a configuration example of the access point 12. The access point 12 includes a database unit 21, a control signal transmission/reception unit 22, and a scheduler unit 23. The access point 12 can also be realized by a computer and a program, and the program can be recorded in a recording medium or provided through a network.

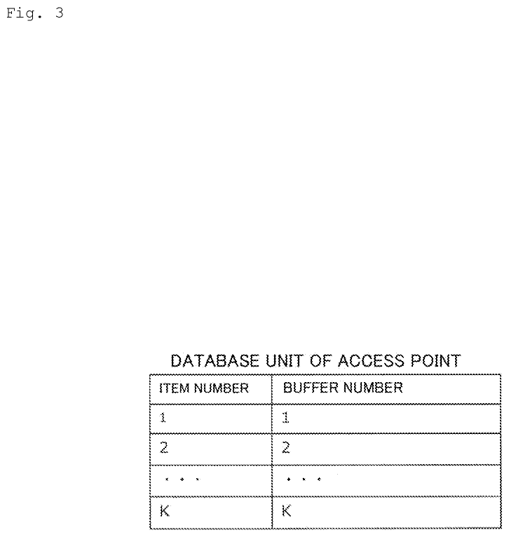

FIG. 3 illustrates an example of information stored in the database unit 21. The database unit 21 organizes information of flow-based buffers FB2 #1 to FB2 #K of its own device. Thus, in the present embodiment, the access point 12 records its own buffer number in its own database unit 21.

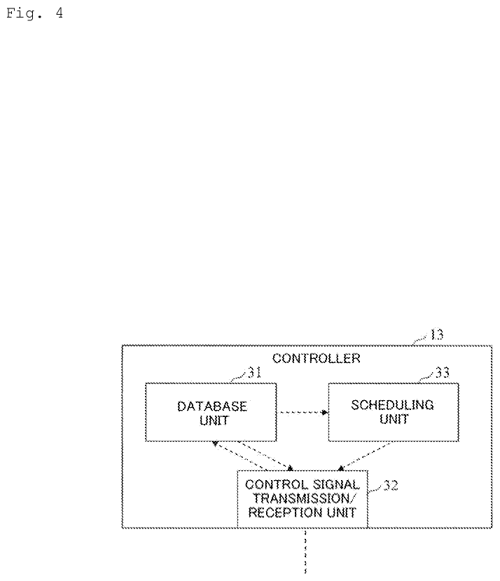

FIG. 4 illustrates a configuration example of the controller 13. The controller 13 includes a database unit 31, a control signal transmission/reception unit 32, and a scheduling unit 33. The controller 13 can also be realized by a computer and a program, and the program can be recorded in a recording medium or provided through a network.

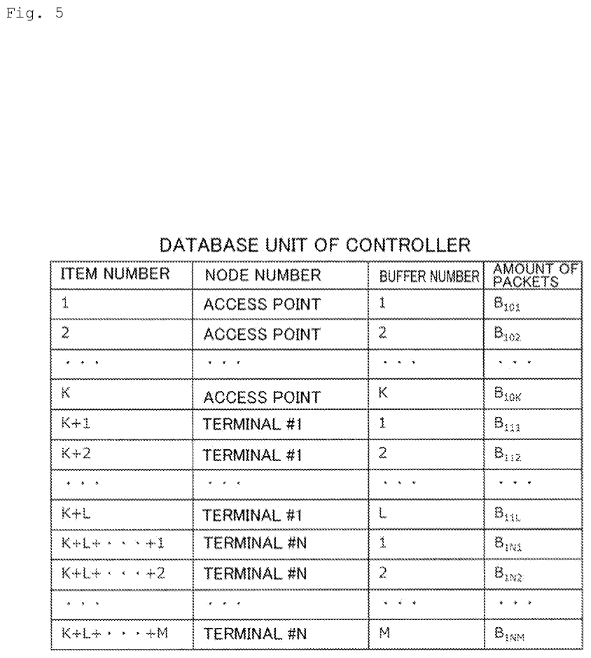

The database unit 31 organizes information about a flow-based buffer in the access point 12 and the terminal 11. FIG. 5 illustrates an example of information organized in the database unit 31. The database DB organizes the following three pieces of information.

The item number is a serial number assigned to all buffers (FB1 and FB2) of the terminal 11 and the access point 12.

The node number is the number of the terminal 11.

The buffer number is the number of the buffer FB1 held by each terminal 11 or the number of the buffer FB2 held by the access point 12.

The amount of packets is the accumulated amount of packets held by buffers having respective buffer numbers. For example, the item number K+2 refers to the accumulated amount of packets in a flow-based buffer unit FB1 #2 of a terminal 11 #1, indicating that the amount is “B12.”

When the terminal 11 #N+1 is newly connected, the node number and the buffer number of the terminal 11 #N+1 are not stored in the database unit 31.

The information about the access point 12 is stored in the database unit 31 when the access point 12 is installed. At this time, the protocol compatible with the access point 12 is also stored in the database unit 31.

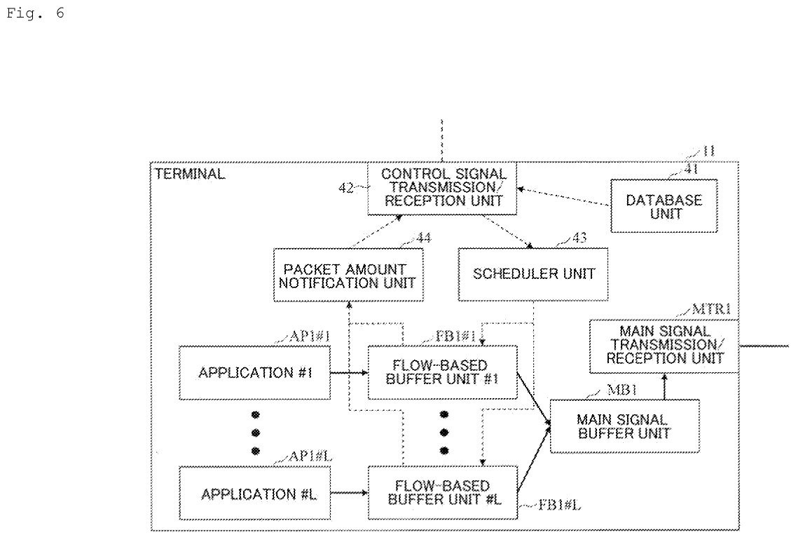

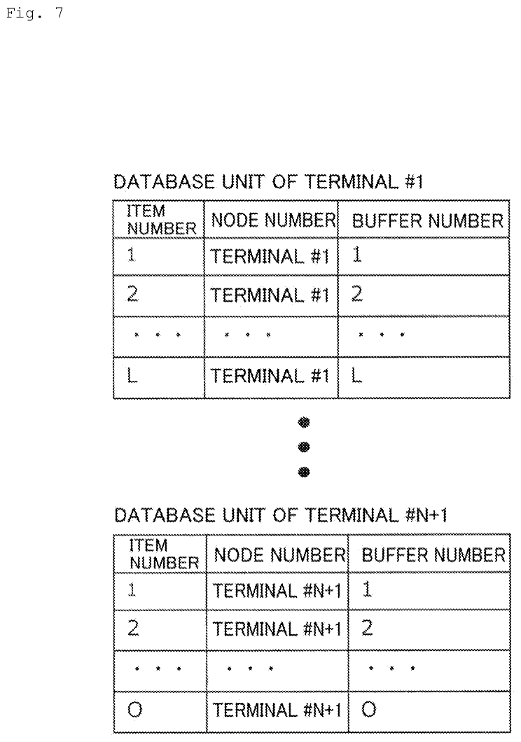

FIG. 6 illustrates a configuration example of the terminal 11. The terminal 11 includes a database unit 41, a control signal transmission/reception unit 42, and a scheduler unit 43. FIG. 7 illustrates an example of information stored in the database unit 41. The database unit 41 organizes information about node numbers and flow-based buffers FB1 #1 to FB1 #L of its own device. Thus, in the present embodiment, each terminal 11 records its own node number and buffer number in its own database unit 41.

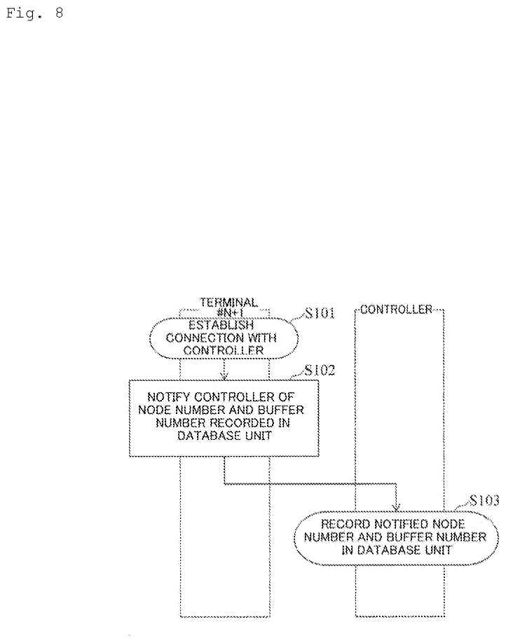

FIG. 8 illustrates a flowchart of the terminal 11 #N+1 making a new connection.

The newly connected terminal 11 #N+1 establishes a connection with the controller 13 in accordance with a connection sequence according to a protocol available in the wireless network 15 before connecting to the access point 12 (S101). The newly connected terminal 11 #N+1 notifies the controller 13 of the node number and the buffer number recorded in the database unit 11 as the newly connected terminal after the connection with the controller 13 (S102).

The controller 13 records the node number #N+1 of the terminal 11 #N+1 and the buffer number held by the terminal 11 #N+1 in the database unit 31 (S103).

Thus, the node numbers and buffer numbers of all the terminals 11 #1 to 11 #N+1 can be recorded in the controller 13 in advance.

Here, in step S101, a protocol used when the controller 13 establishes a connection with the terminal 11 #N+1 follows the protocol of the wireless network 15 available for the terminal 11 #N+1. For example, the controller 13 receives a radio signal by which the terminal 11 #N+1 searches for the access point 12, and establishes a connection with the terminal 11 #N+1 by a connection sequence according to a protocol suitable for the received radio signal.

Communication between the terminal 11 #N+1 and the controller 13 may use a different protocol from data communication between the terminal 11 #N+1 and the access point 12. For example, the communication between the terminal 11 #N+1 and the controller 13 is performed by using a low-speed protocol capable of communication even when radio waves are weak, and the communication between the terminal 11 #N+1 and the access point 12 is performed by using a high-speed protocol.

After step S103, the terminal 11 notifies the controller 13 of a band required by the application. The controller 13 records the notified required band in the database unit 31, determines a band control value of each traffic flow for each terminal 11 and access point 12 on the basis of the recorded information of the database unit, and notifies each terminal 11 and the access point 12 of the band control value. Each terminal 11 and the access point 12 transmit a packet of each traffic within the notified band control value range. Thus, the present disclosure enables band allocation in a fine traffic flow basis such as a service and application in a real wireless network.

### Second Embodiment

The newly connected terminal 11 #N+1 cannot know whether or not the node number and the buffer number notified by itself are surely recorded in the controller 13. There is a likelihood that notification will be damaged or lost due to packet loss or the like in normal communication. Therefore, in the present embodiment, the node number and the buffer number of the newly connected terminal 11 #N+1 are surely notified to the controller 13.

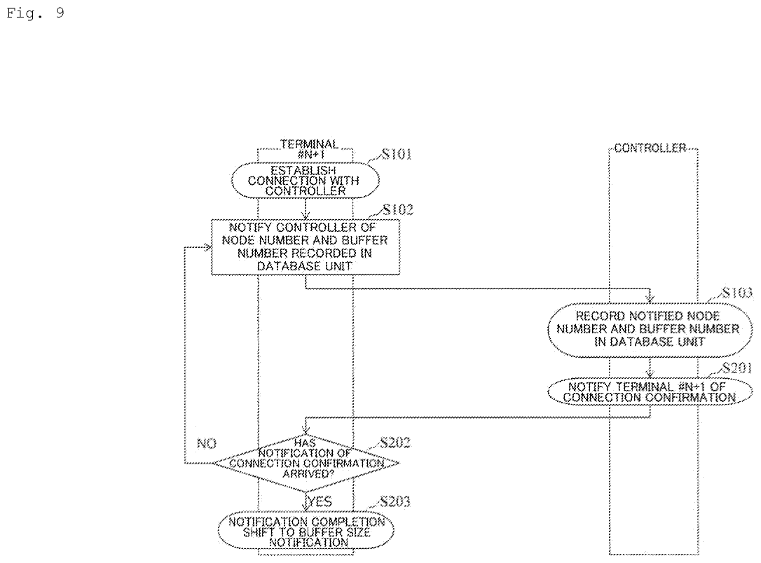

FIG. 9 illustrates a flowchart of the terminal 11 #N+1 making a new connection. In the present embodiment, the following steps are executed after step S103 shown in FIG. 8.

The controller 13 notifies the newly connected terminal 11 #N+1 of connection confirmation indicating that data is recorded in the database unit when the data is recorded in the database unit 31 (S201).

The newly connected terminal 11 #N+1 transmits a node number and a buffer number to be notified at the time of connection a plurality of times until the notification of connection confirmation from the controller 13 arrives (S202).

The terminal 11 #N+1 notifies the controller 13 of the buffer size when the notification of the connection confirmation arrives (S203).

Even after the controller 13 records the node number and the buffer number of the terminal 11 #N+1 in the database unit 31, the node number and the buffer number may be received from the terminal 11 #N+1. In such a case, the controller 13 re-transmits the notification of connection confirmation.

### Third Embodiment

Each of the terminal 11 and the access point 12 includes: buffers (FB1 and FB2) which accumulate transmission packets for each traffic flow; control signal transmission/reception units (42 and 22) which transmit, to the controller 13, an accumulated amount of the transmission packets for each traffic flow accumulated in the buffers (FB1 and FB2) and receive a transmission time and a transmission amount of the transmission packets for each traffic flow from the controller 13; and
main signal transmission units (MTR1 and MTR2) which transmit the transmission packets for traffic flow in the buffers (FB1 and FB2) to the wireless network 15 according to the transmission time and the transmission amount.

The control signal transmission/reception unit 32 receives the accumulated amount from each of the terminal 11 and the access point 12 and transmits the transmission time and the transmission amount to each of the terminal 11 and the access point 12. The scheduling unit 33 determines the transmission time and the transmission amount of the transmission packets for each traffic flow on the basis of the accumulated amount.

Each terminal 11 and the access point 12 periodically notifies the controller 13 of the amount of packets accumulated in the flow-based buffer units (FB1 and FB2) as a control signal. The terminal 11 accumulates packets from each application AP1 in the buffer FB1 for each application (for each flow). A packet amount notification unit 44 periodically checks the accumulated amount of packets in each buffer FB1 and notifies the controller 13 of the accumulated amount of packets as a control signal via the control signal transmission/reception unit 42.

Also, the access point 12 accumulates packets from an upper layer network device 50 in the buffer FB2 for each application (for each flow). A packet amount notification unit 24 periodically checks the accumulated amount of packets in each buffer FB2 and notifies the controller 13 of the accumulated amount of packets as a control signal via the control signal transmission/reception unit 22.

Note that the application AP1 may have the flow-based buffer unit FB1.

The controller 13 records the notified accumulated amount of packets and information about the terminal 11, the access point 12, and the flow-based buffers (FB1 and FB2), determines a transmission time and a transmission amount for each buffer on the basis of the recorded information, and notifies each terminal 11 and the access point 12 of the information as a control signal.

The control signal transmission/reception unit 32 of the controller 13 receives control signals from each terminal 11 and the access point 12 and organizes the accumulated amount of packets and the information about the terminal 11, the access point 12, and the flow-based buffers (FB1 and FB2) included in the control signals in the database DB 31.

The scheduling unit 33 of the controller 13 determines the transmission time and the transmission amount for each buffer from the content of the database unit DB 31 using a scheduling method which will be described later. The scheduling unit 33 then uses the determined transmission time and transmission amount as a control signal and transmits the control signal from the control signal transmission/reception unit 32 to the terminal 11 or the access point 12.

Each terminal 11 and the access point 12 take out packets accumulated in the flow-based buffer units (FB1 and FB2) according to the notified transmission time and transmission amount and input the packets to main signal buffer units (MB1 and MB2). The main signal transmission/reception units (MTR1 and MTR2) transmit packets of main signal buffer units (MB1 and MB2) to the wireless network 15.

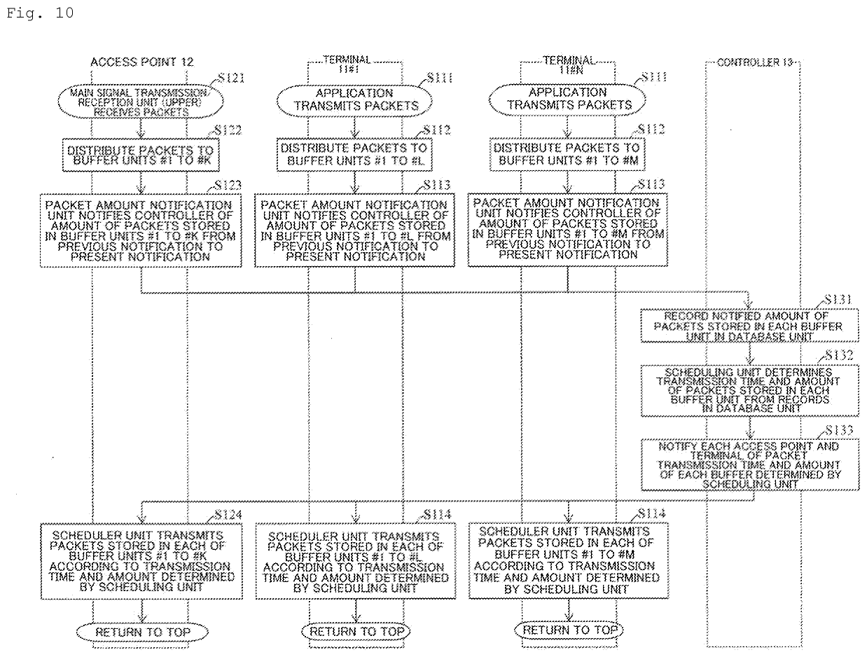

FIG. 10 is a flowchart illustrating the operations described above. The control method according to the present embodiment is a control method for controlling traffic in the wireless network 15,
the control method being transmission control performed by the controller 13 on the terminal 11 and the access point 12 which mutually transmit packets over the wireless network 15, the control method including:
accumulating transmission packets in respective buffers (FB1 and FB2) of the terminal 11 and the access point 12 for each traffic flow (steps S111, S112, S121, and S122);
transmitting, to the controller, the accumulated amount of the transmission packets for each traffic flow accumulated in each of the buffers (steps S113 and S123);
determining, by the controller, a transmission time and a transmission amount of the transmission packets for each traffic flow on the basis of the accumulated amount received from each of the terminal and the access point (steps S131 and S132);

transmitting the transmission time and the transmission amount from the controller to each of the terminal and the access point (step S133); and
transmitting, to the wireless network, the transmission packets for each traffic flow from the respective buffers of the terminal and the access point according to the transmission time and the transmission amount (steps S114 and S124).

### Effects

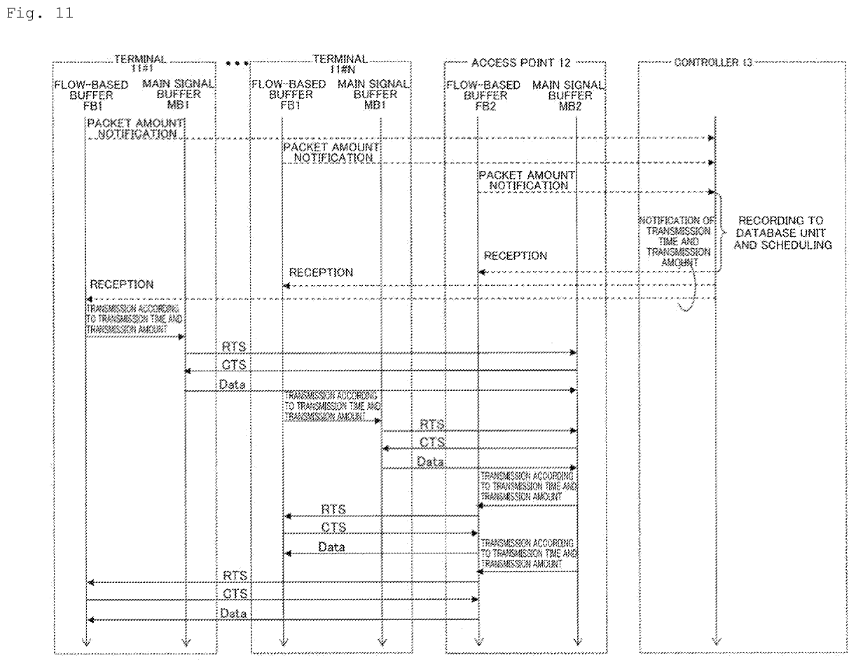

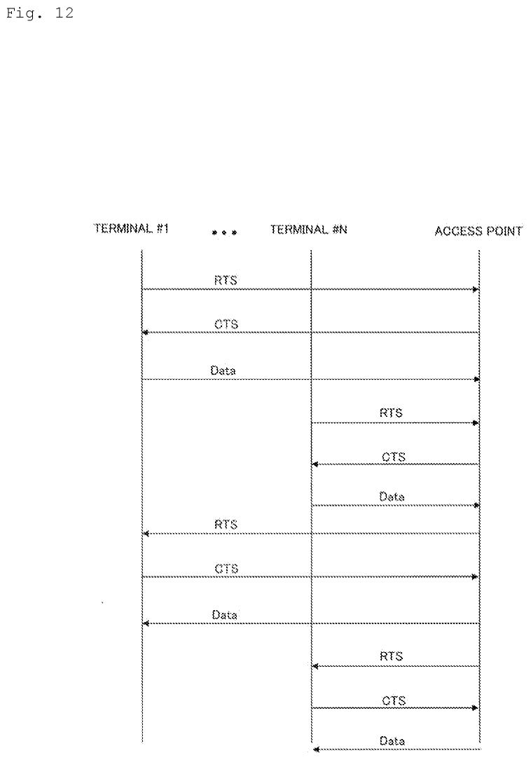

FIGS. 11 and 12 are diagrams illustrating the effects of the control system of the present disclosure. FIG. 11 is a sequence diagram of the control system of the present disclosure, and FIG. 12 is a sequence diagram of a conventional communication system with no controller 13. In FIGS. 11 and 12, “RTS” means a transmission request (Request To Send), and “CTS” means a transmission permission (Clear to Send). Further, a solid line means communication of the main signal, and a broken line means communication of the control signal.

As can be understood from comparison between FIGS. 11 and 12, the communication operation from the main signal buffers (MB1 and MB2) in FIG. 11 is the same as the communication operation in FIG. 12. The control system of the present disclosure can be realized by disposing the controller 13 without modifying the existing communication system. Since no transmission time control is carried out in the communication operation in FIG. 12, there are troubles such as packet collisions and non-uniformity about terminals or access points allowed to transmit, while the control system of the present disclosure controls transmission time with respect to terminals and access points, and therefore the troubles are resolved.

### [Scheduling Method]

Here, a scheduling method performed by the scheduling unit 33 of the controller 13 will be described.

### [1] Fair Scheduling

This scheduling method is calculated by dividing the band or time by the total number of flow-based buffers in which packets are accumulated among the flow-based buffers (FB1 and FB2) of the terminal 11 and the access point 12.

The parameters will be described below.

Number of flow-based buffers in which packets are accumulated in the terminal 11 and the access point 12: n
One cycle time: T [sec]
Main signal total transmission limit amount per cycle time: Z [Bytes/sec]
Time to transmit the first accumulated packet: tₛₜₐᵣₜ [sec]

In this case,

The transmission amount S_{J} [Bytes] of the flow-based buffer #J is calculated as follows.

$$\begin{matrix}[ Math . 1 ] & \\ {S}_{J} = \frac{Z}{n} & ( 1 )\end{matrix}$$

The transmission time interval T_{J} [sec] of the flow-based buffer #J is calculated as follows.

$$\begin{matrix}[ Math . 2 ] & \\ {T}_{J} = \frac{T}{n} & ( 2 )\end{matrix}$$

The transmission time t_{J} [sec] of the flow-based buffer #J is calculated as follows.

$$\begin{matrix}[ Math . 3 ] & \\ {t}_{J} = {t}_{start} + {\sum }_{J = 1} {T}_{J - 1} & ( 3 )\end{matrix}$$

It is conceivable that the order of the flow-based buffers to start transmission is, for example, starting from the lowest item number organized in the database unit DB 31 of the controller 13.

### [2] Scheduling in Consideration of Band Weighting

This scheduling method is determined by the number of flow-based buffers in which packets are accumulated and the accumulated amount of packets among the flow-based buffers (FB1 and FB2) of the terminal 11 and the access point 12. The parameters will be described below.
Accumulated amount of packets in the flow-based buffer #J: B_{J} [Bytes]
One cycle time: T [sec]
Transmission limit amount per cycle time: Z [Bytes/sec]
Time required to transmit all the packets accumulated in all the flow-based buffers: Tₐₗₗ [sec]
Time to transmit the first packet among the packets accumulated in all the flow-based buffers: tₛₜₐᵣₜ [sec]

In this case,

$$\begin{matrix}[ Math . 4 ] & \\ {T}_{a l l} = \frac{{\sum }_{J = 1} {B}_{J}}{Z} & ( 4 )\end{matrix}$$

if the above equation is satisfied,
the transmission amount S_{J} [Bytes] of the flow-based buffer #J is calculated as follows when Tₐₗₗ≤T.

$$\begin{matrix}[ Math . 5 a ] & \\ {S}_{J} = {B}_{J} & ( 5 a )\end{matrix}$$

The transmission amount S_{J} [Bytes] of the flow-based buffer #J is calculated as follows when Tₐₗₗ>T.

$$\begin{matrix}[ Math . 5 b ] & \\ {S}_{J} = \frac{T}{{T}_{all}} {B}_{J} & ( 5 b )\end{matrix}$$

The transmission time interval T_{J} [sec] of the flow-based buffer #J is calculated as follows when Tₐₗₗ≤ T.

$$\begin{matrix}[ Math . 6 a ] & \\ {T}_{J} = \frac{{S}_{J}}{{\sum }_{J = 1} {B}_{J}} {T}_{a l l} & ( 6 a )\end{matrix}$$

The transmission time interval T_{J} [sec] of the flow-based buffer #J is calculated as follows when Tₐₗₗ>T.

$$\begin{matrix}[ Math . 6 b ] & \\ {T}_{J} = \frac{{S}_{J}}{{\sum }_{J = 1} {B}_{J}} {T}_{a l l} & ( 6 b )\end{matrix}$$

The transmission time t_{J} [sec] of the flow-based buffer #J is calculated as follows when Tₐₗₗ≤ T.

$$\begin{matrix}[ Math . 7 a ] & \\ {t}_{J} = {t}_{start} + {\sum }_{J = 1} {T}_{J - 1} & ( 7 a )\end{matrix}$$

The transmission time t [sec] of the flow-based buffer #J is calculated as follows when Tₐₗₗ>T.

$$\begin{matrix}[ Math . 7 b ] & \\ {t}_{J} = {t}_{start} + {\sum }_{J = 1} {T}_{J - 1} & ( 7 b )\end{matrix}$$

Note that when Tₐₗₗ>T, packets yet to be transmitted remain unsent until next transmission timing.

### INDUSTRIAL APPLICABILITY

The present disclosure is applicable to information and communication industries.

### REFERENCE SIGNS LIST

11: Terminal
12: Access point
13: Controller
15: Wireless network
21, 31, 41: Database unit
22, 32, 42: Control signal transmission/reception unit
23, 43: Scheduler unit
24, 44: Packet amount notification unit
33: Scheduling unit

1. A control system for controlling traffic in a wireless network, the control system comprising:
a terminal and an access point which mutually transmit packets over the wireless network; and
a controller which performs transmission control on the terminal and the access point, wherein:
the terminal holds in advance information about a node number and a flow-based buffer of its own device;
before the access point establishes a connection with the terminal, the controller establishes a connection with the terminal using a connection sequence according to a protocol available in the wireless network, and
acquires, from the terminal, the information about the node number and the flow-based buffer of the terminal through the wireless network; and
after the access point establishes a connection with the terminal, the controller performs transmission control for each traffic flow accumulated in the flow-based buffer of the terminal using the information about the node number and the flow-based buffer of the terminal acquired through the wireless network.

2. The control system according to claim 1, wherein, when acquiring the information about the node number and the flow-based buffer from the terminal, the controller notifies the terminal of connection confirmation indicating that the information has been acquired.

3. A control method for controlling traffic in a wireless network,
the control method being transmission control performed by a controller on a terminal and an access point which mutually transmit packets over the wireless network, the control method comprising:
before the access point establishes a connection with the terminal,
by the controller,
establishing a connection with the terminal using a connection sequence according to a protocol available in the wireless network, and
acquiring, from the terminal, information about a node number and a flow-based buffer of its own device held in advance by the terminal through the wireless network; and
after the access point establishes a connection with the terminal,
by the controller, performing transmission control for each traffic flow accumulated in the flow-based buffer of the terminal using the information about the node number and the flow-based buffer of the terminal acquired through the wireless network.

4. A controller for controlling traffic in a wireless network, the controller being a device that performs transmission control on a terminal and an access point which mutually transmit packets over the wireless network, wherein:
before the access point establishes a connection with the terminal,
the controller establishes a connection with the terminal using a connection sequence according to a protocol available in the wireless network, and
acquires, from the terminal, information about a node number and a flow-based buffer of its own device held in advance by the terminal through the wireless network; and
after the access point establishes a connection with the terminal,
the controller performs transmission control for each traffic flow accumulated in the flow-based buffer of the terminal using the information about the node number and the flow-based buffer of the terminal acquired through the wireless network.

5. A non-transitory computer-readable medium having computer-executable instructions that, upon execution of the instructions by a processor of a computer, cause the computer to function as the controller according to claim 4.
